(19) United States
(12) Patent Application Publication
(10) Pub. No.: US 2014/0164243 A1
(43) Pub. Date: Jun. 12, 2014

(54) Dynamic Account Identifier With Return Real Account Identifier

(71) Applicants: Christian Aabye, Foster City, CA (US); Brian Byrne, San Francisco, CA (US)

(72) Inventors: Christian Aabye, Foster City, CA (US); Brian Byrne, San Francisco, CA (US)

(21) Appl. No.: 14/101,169

(22) Filed: Dec. 9, 2013

Related U.S. Application Data
(60) Provisional application No. 61/734,863, filed on Dec. 7, 2012.

(51) Int. Cl. G06Q 20/38

(52) U.S. Cl. CPC G06Q 20/3825
USPC 705/44

(57) ABSTRACT

Embodiments of the invention are directed to systems, apparatus, and methods for receiving an account token for a transaction, and returning an associated real account identifier if the transaction is approved. In one embodiment, an authorization request message for a transaction is received by a server computer, the authorization request message including an account token associated with a real account identifier. The server computer determines the real account identifier associated with the account token. If the transaction is approved, an authorization response message including the real account identifier is transmitted.

### CROSS-REFERENCES TO RELATED APPLICATIONS

The present application is a non-provisional application of and claims priority to U.S. Provisional Application No. 61/734,863, filed on Dec. 7, 2012, the entire contents of which are herein incorporated by reference for all purposes.

### BACKGROUND

The use of tokenization is becoming increasingly popular in the context of electronic payment transactions using credit card accounts, debit card accounts, prepaid accounts, checking accounts, and the like. Tokenization refers to the process of converting financial account information, such as a primary account number (PAN) or other real account identifier into an account token, which may be used in lieu of the real account identifier to conduct an electronic payment transaction with a merchant for goods or services. For instance, a tokenization algorithm can be used to transform a real account identifier into an account token by replacing all or a portion of the real account identifier with one or more valueless stand-in numbers, letters, symbols, or other characters, or the real account identifier can be replaced altogether by a different static or dynamic value.

Account tokens may be stored and utilized by merchants and acquirers (e.g., in customer “cards on file” databases), by users (e.g., on a payment card or accessible via an electronic wallet client facilitated by a mobile device), issuers, processors, and other entities that participate in electronic payment transactions. Although the use of account tokens can provide advantages such as improved security and convenience, such tokens may also introduce a number of disadvantages. For instance, merchants or acquirers may need access to real account identifiers to facilitate returns, refunds, and other post-transaction activity. Similarly, since the relationship between an account token and a specific user may not be readily ascertainable, real account identifiers may be needed by merchants or acquirers to perform services such as customer loyalty programs, analytics, targeted marketing, and the like. Moreover, account token formats may be incompatible with existing clearing and settlement processes and infrastructure utilized by acquirers, issuers, payment processing networks, and the like.

Some of the aforementioned disadvantages may be remedied by real account identifiers being provided to merchants and their acquirers as part of the electronic payment transaction flow. However, providing such sensitive information for all transactions may negate many of the advantages provided by account tokens, such as the ability to protect the customer's privacy from hackers, fraudsters, and unscrupulous merchants.

Embodiments of the present invention address these problems and other problems individually and collectively.

### BRIEF SUMMARY

Embodiments of the invention are directed to systems, apparatus, and methods for receiving an account token for a transaction, and returning an associated real account identifier if the transaction is approved.

One embodiment of the invention is directed to a method. The method comprises receiving, by a server computer, an authorization request message for a transaction, the authorization request message including an account token associated with a real account identifier. The server computer determines the real account identifier associated with the account token. If the transaction is approved, an authorization response message including the real account identifier is transmitted.

Another embodiment of the invention is directed to a server computer comprising a processor and a computer-readable medium coupled to the processor. The computer-readable medium includes code executable by a processor for performing a method. The method comprises receiving an authorization request message for a transaction, the authorization request message including an account token associated with a real account identifier. The real account identifier associated with the account token is determined. If the transaction is approved, an authorization response message including the real account identifier is transmitted.

Another embodiment of the invention is directed to a method comprising receiving, by a merchant computer, an account token from a payment device, the account token being associated with a real account identifier. The merchant computer transmits an authorization request message for a transaction to a server computer, the authorization request message including the account token. The server computer determines the real account identifier associated with the account token and, if the transaction is approved, transmits an authorization response message including the real account identifier.

Another embodiment of the invention is directed to a system comprising a payment device, a merchant computer, and a server computer. The payment device is configured to store an account token associated with a real account identifier. The merchant computer is configured to receive the account token from the payment device, and transmit an authorization request message for a transaction including the account token. The server computer is configured to receive the authorization request message including the account token from the merchant computer, determine the real account identifier associated with the account token, and transmit an authorization response message including the real account identifier if the transaction is approved.

These and other embodiments of the invention are described in detail below.

### BRIEF DESCRIPTION OF THE DRAWINGS

FIG. 1 illustrates a block diagram of an exemplary payment processing system in accordance with some embodiments.

FIG. 2 illustrates a block diagram of an exemplary payment processing network including a server computer in accordance with some embodiments.

FIG. 3 shows a flowchart illustrating an exemplary method of processing payment transactions by a payment processing network in accordance with some embodiments.

FIG. 4 shows a flowchart illustrating an exemplary method of processing payment transactions by an issuer computer in accordance with some embodiments.

FIG. 5 illustrates a block diagram of an exemplary computer system.

### DETAILED DESCRIPTION

Embodiments of the invention are directed to systems, apparatus, and methods for receiving an account token for a transaction, and returning an associated real account identifier if the transaction is approved.

Prior to discussing embodiments of the invention, a further description of some terms may be helpful in understanding embodiments of the invention.

An “authorization request message” may be an electronic message that is sent to a payment processing network and/or an issuer of a payment card to request authorization for a transaction. An authorization request message according to some embodiments may comply with ISO 8583, which is a standard for systems that exchange electronic transaction information associated with a payment made by a consumer using a payment device or payment account. The authorization request message may include an issuer account identifier that may be associated with a payment device or payment account. An authorization request message may also comprise additional data elements corresponding to “identification information” including, by way of example only: a service code, a CVV/iCVV (card verification value), a dCVV (dynamic card verification value), a cryptogram (e.g., a unique cryptographic value for the transaction), an expiration date, etc. An authorization request message may also comprise “transaction information,” such as any information associated with a current transaction, such as the transaction amount, merchant identifier (e.g., MVV), merchant location, merchant category code, etc., as well as any other information that may be utilized in determining whether to authorize a transaction.

An “authorization response message” may be an electronic message reply to an authorization request message generated by an issuing financial institution or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization may also include “identification information” as described in further detail below. The authorization response message may also include an authorization code, which may be a code that a credit card issuing bank returns in response to an authorization request message in an electronic message (either directly or through the payment processing network) to the merchant's access device (e.g., POS equipment) that indicates approval of the transaction. The code may serve as proof of authorization. As described below, in some embodiments, a payment processing network may generate or forward the authorization response message to the merchant or an acquirer of the merchant.

“Identification information” may include any suitable information associated with an account (e.g., a payment account and/or payment device associated with the account). Such information may be directly related to the account or may be derived from information related to the account. Examples of account information may include a “real account identifier” such as a PAN (primary account number), “account token,” user name, expiration date, CVV/iCVV (card verification value), dCVV (dynamic card verification value), CVV2 (card verification value 2), CVC3 card verification values, cryptograms, etc. CVV/iCVV and CVV2 are generally understood to be static verification values associated with a payment device, whereas dCVV and cryptograms are generally understood to be dynamic verification values. CVV2 values are generally visible to a user (e.g., a consumer), whereas CVV/iCVV, dCVV, and cryprogram values are typically embedded in memory or authorization request messages and are not readily known to the user (although they are known to the issuer and payment processors).

A “payment device” may include any device that may be used to conduct a financial transaction, such as to provide payment information to a merchant. A payment device may be in any suitable form. For example, suitable payment devices can be hand-held and compact so that they can fit into a consumer's wallet and/or pocket (e.g., pocket-sized). They may include smart cards, magnetic stripe cards, keychain devices (such as the Speedpass™ commercially available from Exxon-Mobil Corp.), etc. Other examples of payment devices include security cards, access cards, smart media, transponders, 2-D barcodes, an “electronic” or “digital wallet,” and the like. If the payment device is in the form of a debit, credit, smartcard, or other payment card, the payment device may also optionally have features such as magnetic stripes. Payment devices can operate in a contact mode (e.g., with magnetic stripe data being read by a contact-based access device) and/or in contactless mode (e.g., by transmitting data to a contactless access device using radio frequency (RF) communication or other wireless protocol). Suitable payment devices may also include “stationary” devices such as desktop computers and the like.

In some embodiments, exemplary payment devices can include “mobile devices.” A “mobile device” may comprise any electronic device that may be transported and operated by a user, which may also provide remote communication capabilities to a network. Examples of remote communication capabilities include using a mobile phone (wireless) network, wireless data network (e.g., 3G, 4G, or similar networks), Wi-Fi, Wi-Max, or any other communication medium that may provide access to a network such as the Internet or a private network. Examples of mobile devices include mobile phones (e.g., cellular phones), PDAs, tablet computers, net books, laptop computers, personal music players, hand-held specialized readers, etc. Mobile devices may facilitate an “electronic” or “digital wallet.” A mobile device may comprise any suitable hardware and software for performing such functions, and may also include multiple devices or components (e.g., when a device has remote access to a network by tethering to another device—i.e. using the other device as a modem—both devices taken together may be considered a single mobile device).

An “electronic wallet” or “digital wallet” can store user profile information, payment information, bank account information, and/or the like and can be used in a variety of transactions, such as but not limited to eCommerce, social networks, money transfer/personal payments, mobile commerce, proximity payments, gaming, and/or the like for retail purchases, digital goods purchases, utility payments, purchasing games or gaming credits from gaming websites, transferring funds between users, and/or the like. As described in further detail below, an electronic or digital wallet can store “real account identifiers” and/or “account tokens.”

A “real account identifier” may include any information that directly identifies a payment account such as a credit card account, a checking account, a prepaid account, and the like. A real account identifier can be represented as a sequence of characters or symbols (e.g., a 16 digit PAN). Exemplary real account identifiers include, but are not limited to, credit card account numbers, debit card numbers, checking and savings account numbers, prepaid account numbers, and the like.

An “account token” may refer to the result of transforming a real account identifier into a form that is not considered sensitive in the context of the environment in which the account token is used or resides. For instance, in some embodiments, a “token derivation key” may be used to perform a tokenization algorithm where a real account identifier is transformed into an account token. The tokenization algorithm may produce the account token by replacing sensitive data, or portions thereof, in the real account identifier with one or more characters that are not considered sensitive. Similarly, a “reverse tokenization key” can be used to perform a reverse tokenization algorithm where the account token is transformed back into the real account identifier. In some embodiments, account tokens may be “single-use tokens” such that they are usable for only a single transaction. In other embodiments, account tokens may be “multi-use tokens” such that they are usable for multiple transactions. In some further embodiments, an account token may include any suitable information considered less sensitive than the corresponding real account identifier. For instance, account tokens may include an alias, e-mail address, phone number, zip code, or any other suitable information.

A “token derivation key” may include any piece of information used generate an account token corresponding to a real account identifier. A token derivation key may be used as a parameter of a tokenization algorithm, and may vary the output of a tokenization algorithm. In some embodiments, a token derivation key is symmetric such that the same token derivation key may be used for both tokenization and reverse tokenization. In other embodiments, a token derivation key is asymmetric such that the token derivation key used to tokenize an account identifier may not be used in the reverse tokenization algorithm. Instead, a “reverse tokenization key” may be used to transform an account token back into a real account identifier.

A “server computer” may include any suitable computer that can provide communications to other computers and receive communications from other computers. A server computer may include a computer or cluster of computers. For instance, a server computer can be a mainframe, a minicomputer cluster, or a group of servers functioning as a unit. In one example, a server computer may be a database server coupled to a Web server. A server computer may be coupled to a database and may include any hardware, software, other logic, or combination of the preceding for servicing the requests from one or more client computers. A server computer may comprise one or more computational apparatuses and may use any of a variety of computing structures, arrangements, and compilations for servicing the requests from one or more client computers. Data transfer and other communications between components such as computers may occur via any suitable wired or wireless network, such as the Internet or private networks.

Embodiments of the invention are directed to systems, apparatus, and methods for receiving an account token for a transaction, and returning an associated real account identifier if the transaction is approved. In some embodiments, an authorization request message for a transaction can be received by a server computer, the authorization request message including an account token. The server computer can determine a real account identifier associated with the account token (e.g., via a look-up and/or reverse tokenization process). If the transaction is approved (e.g., by the account issuer), an authorization response message including the real account identifier can then be transmitted by the payment processing network to an acquirer, merchant, or other entity. Alternatively, if the transaction is not approved, an authorization response message including the account token can instead be transmitted.

To illustrate, when a user opens a credit card account, the user may be issued a payment device provisioned to store or generate a token when conducting an electronic payment transaction. The token may be an encrypted version of the primary account number (PAN) corresponding to the credit card account or, as another example, a value different from the PAN but linked to the PAN in a database. When the user conducts a transaction at a merchant using the payment card, the user can present the card to a merchant access device (e.g., a contactless POS terminal). The account token can be passed from the card to the POS terminal, and the POS terminal may then generate an authorization request message for the transaction including the account token. The authorization request message can be transmitted by a merchant computer to an acquirer of the merchant, and from the acquirer to a payment processing network.

The payment processing network may then transform the account token included in the authorization request message back into the corresponding PAN. For instance, if the account token is a static data element stored on the payment card, the payment processing network can perform a “look-up” process whereby the network accesses a database that maps the account token to the original PAN. As another example, if the token is dynamically generated by the payment card, the payment processing network may perform a reverse tokenization process whereby the account token is converted back into the PAN using a reverse tokenization key. The authorization request message including the PAN may then be forwarded by the network to the issuer for authorization of the transaction.

Upon receipt of the authorization request message, the issuer may determine whether to authorize the transaction, and may generate an authorization response message including the PAN and an indication (e.g., an authorization code) of whether the transaction is approved or declined. This authorization response message can be transmitted by the issuer to the payment processing network. If the transaction is approved, the payment processing network can forward the authorization response message including the PAN to the merchant via the acquirer. The merchant and/or acquirer may then store a record of the transaction including the PAN for purposes of clearing, settlement, a return or refund, etc. Alternatively, if the transaction is declined by the issuer, the payment processing network can instead replace the PAN with the account token, and may then forward the authorization response message including the account token to the merchant via the acquirer. Since the transaction was declined by the issuer, the merchant and/or acquirer may not need to store a record of the transaction including the sensitive PAN, since no subsequent clearing, settlement, return, or refund may occur.

As another illustration, in some embodiments, the issuer may instead receive and reverse tokenize the account token, and may determine whether to include the PAN in the authorization response message. For instance, upon receipt of the authorization request message including the account token, the payment processing network may forward the authorization request message including account token to the issuer. The issuer may then determine the PAN associated with the account number (e.g., via a look-up process, reverse tokenization algorithm, etc.), and may then determine whether to authorize the transaction. If the issuer decides to authorize the transaction, the issuer may generate an authorization response message including the PAN, and may forward this authorization response message to the merchant via the payment processing network and acquirer. The merchant may then store a record of the transaction including the PAN. If, however, the issuer declines authorization of the transaction, the issuer can generate an authorization response message including the originally received account token instead of the determined PAN, and can forward this message back to the merchant.

Embodiments of the invention provide a number of advantages. For instance, embodiments allow a merchant access to a customer's PAN or other real account identifier, while safeguarding customer privacy against hackers, fraudsters, an unscrupulous merchants. By only providing the real account identifier to the merchant when the transaction has been approved, the customer has greater assurance that the real account identifier is only shared with parties that need such sensitive information for legitimate business purposes. Thus, customers can retain many of the benefits of tokenization such as convenience and improved security, while allowing merchants to use real account identifiers to improve service or operations. For instance, merchants can use real account identifiers to facilitate returns, refunds, customer loyalty programs, customer analytics, targeted marketing, etc. Further, by receiving the real account identifier for only approved transactions, compliance by merchants and acquirers with industry and governmental security and privacy standards may be made more feasible.

Moreover, embodiments of the invention also provide the technical advantage of allowing an account token to be used for transactions in an existing clearing and settlement system. In some embodiments, the issuer or acquirer may only support clearing and settling of transactions using real account identifiers. Such systems may not support transactions initiated and processed using account tokens, as an acquirer may not be privy to the reverse tokenization keys, algorithms, or databases used to transform an account token into the corresponding real account identifier. Embodiments of the invention may enable the transmission of real account identifiers to acquirers, thus allowing such acquirers to clear and settle transactions conducted using account tokens using the same clearing and settlement system already utilized for transactions conducted using real account identifiers.

I. Exemplary Systems

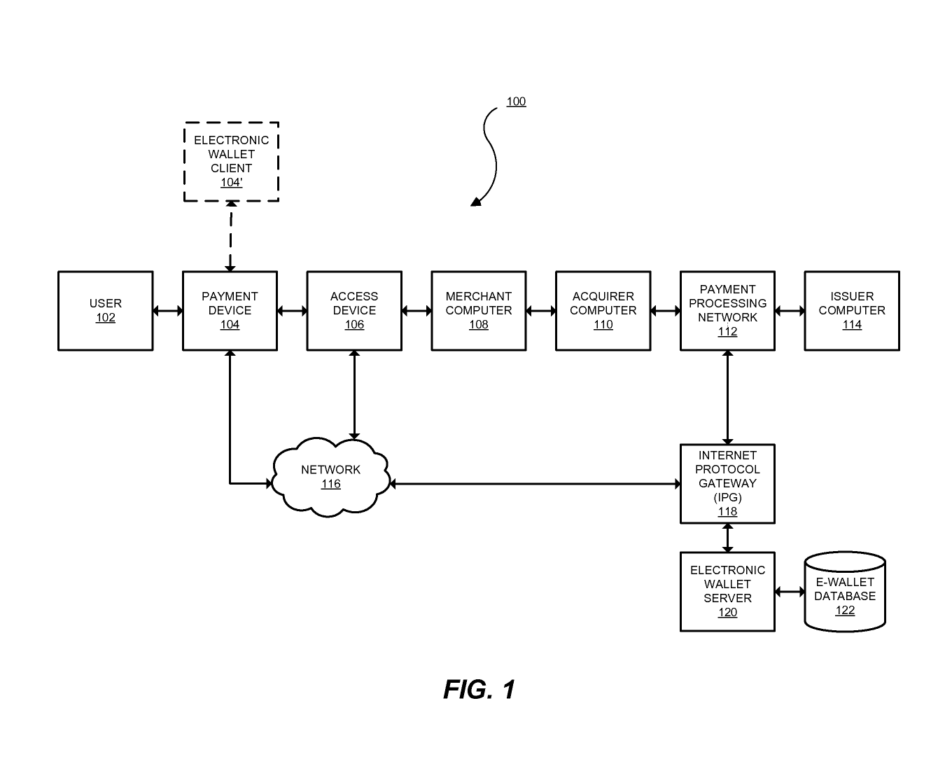

FIG. 1 illustrates a block diagram of an exemplary payment processing system 100 in accordance with some embodiments. Although some of the entities and components in system 100 are depicted as separate, in some instances, one or more of the components may be combined into a single device or location (and vice versa). Similarly, although certain functionality may be described as being performed by a single entity or component within system 100, the functionality may in some instances be performed by multiple components and/or entities (and vice versa). Communication between entities and components may comprise the exchange of data or information using electronic messages and any suitable electronic communication medium and method, as described below.

As illustrated in FIG. 1, system 100 may include one or more merchants, one or more access devices, one or more payment devices, one or more acquirers, one or more payment processing networks, and one or more issuers. For instance, system 100 may include a merchant having a merchant computer 108. As used herein, a “merchant” may refer to an entity that engages in transactions and that can sell goods or services to users. Merchant computer 108 may include an external communication interface (e.g., for communicating with an access device 106 and an acquirer computer 110), system memory comprising one or more modules to generate and utilize electronic messages, and a data processor for facilitating a financial transaction and the exchange of electronic messages. The external communication interface of merchant computer 108 may be coupled to access device 106 such that information may be received by access device 106 and communicated to merchant computer 108 or, in some embodiments, access device 106 may comprise a component of merchant computer 108.

System 100 may further include an acquirer having acquirer computer 110. As used herein, an “acquirer” may refer to a business entity (e.g., a commercial bank or financial institution) that has a business relationship with a particular merchant or similar entity. Acquirer computer 110 may include an external communication interface (e.g., for communicating with merchant computer 108 and a payment processing network 112), system memory comprising one or more modules to generate and utilize electronic messages, and a data processor for facilitating a financial transaction and the exchange of electronic messages.

System 100 may further include an issuer have an issuer computer 114. As used herein, an “issuer” may refer to a business entity (e.g., a bank or other financial institution) that maintains financial accounts for users and that may issue payment devices (e.g., credit cards, debit cards, and the like) or may issue financial accounts accessible via payment devices (e.g., mobile devices) to users. Some entities may perform both issuer and acquirer functions. Issuer computer 114 may include an external communication interface (e.g., for communicating with payment processing network 112), system memory comprising one or more modules to generate and utilize electronic messages, and a data processor for facilitating a financial transaction and the exchange of electronic messages.

As used in this context, an “external communication interface” may refer to any hardware and/or software that enables data to be transferred between two or more components of system 100 (e.g., between devices residing at locations such as an issuer, acquirer, merchant, or payment processing network, etc.). Some examples of external communication interfaces may include a modem, a network interface (such as an Ethernet card), a communications port, a Personal Computer Memory Card International Association (PCMCIA) slot and card, or the like. Data transferred via external communications interface may be in the form of signals which may be electrical, electromagnetic, optical, or any other signal capable of being received by the external communications interface (collectively referred to as “electronic signals” or “electronic messages”). These electronic messages that may comprise data or instructions may be provided between one or more of the external communications interface via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable method.

As would be understood by one of ordinary skill in the art, any suitable communications protocol for storing, representing, and transmitting data between components of system 100 may be used. Some examples of such methods may include utilizing predefined and static fields (such as in core TCP/IP protocols); “Field: Value” pairs (e.g., HTTP, FTP, SMTP, POP3, and SIP); an XML based format; and/or Tag-Length-Value format.

As illustrated in FIG. 1, system 100 may include a user 102 having a payment device 104. User 102 may be an individual, or an organization such as a business that is capable of purchasing goods or services using payment device 104.

Payment device 104 may be in any suitable form. For instance, a suitable payment device can be hand-held and compact so that it can fit into a wallet and/or pocket (e.g., pocket-sized) of user 102. Payment devices may include smart cards, magnetic stripe cards, keychain devices (such as the Speedpass™ commercially available from Exxon-Mobil Corp.), etc. Other examples of payment devices include payment cards, security cards, access cards, smart media, transponders, 2-D barcodes, and the like. If the payment device is in the form of a debit, credit, or smartcard, the payment device may also optionally have features such as magnetic stripes. Such devices can operate in either a contact or contactless mode. Suitable payment devices may also include “stationary” devices such as desktop computers and the like.

In some embodiments, exemplary payment devices can include mobile devices such as mobile phones (e.g., cellular phones), PDAs, tablet computers, net books, laptop computers, personal music players, hand-held specialized readers, etc. Mobile devices may facilitate an “electronic” or “digital wallet.” A mobile device may comprise any suitable hardware and software for performing such functions, and may also include multiple devices or components (e.g., when a device has remote access to a network by tethering to another device—i.e. using the other device as a modem—both devices taken together may be considered a single mobile device).

In some embodiments, as described in further detail below, payment device 104 may be provisioned to store or generate an account token corresponding to a real account identifier (e.g., a PAN) of an account issued by the issuer associated with issuer computer 114. For instance, payment device 104 may include a memory that stores a static account token usable for multiple transactions. As another example, payment device may store (or otherwise have access to) one or more token derivation keys that may be used to generate a unique “single-use” account token when payment device 104 is used to conduct a payment transaction. In some embodiments, an account token or one or more token derivation keys may already be stored on payment device 104 when payment device 104 is issued to user 102. In some embodiments, an account token or one or more token derivation keys may be stored on payment device 104 as part of an enrollment process with payment processing network 112, issuer computer 114, or other entity.

As further illustrated in FIG. 1, information from payment device 104 may be provided to access device 106. In embodiments of the invention, access device 106 may be in any suitable form. Exemplary access devices include point of sale (POS) devices (stationary and mobile), cellular phones, PDAs, desktop computers, laptop computers, tablet computers, handheld specialized readers, set-top boxes, electronic cash registers (ECRs), automated teller machines (ATMs), virtual cash registers (VCRs), kiosks, security systems, access systems, Websites, and the like. Access device 106 may use any suitable contact or contactless mode of operation to send or receive date from, or associated with, payment devices (e.g., payment device 104). In some embodiments, access device 106 may include a reader including one or more of radio frequency (RF) antennas, optical scanners, bar code readers, QR code readers, and magnetic stripe readers to interact with a payment device such as payment device 104.

Information from payment device 104 may be provided to access device 106, either directly (e.g., through a contact or contactless interface) or indirectly (e.g., in an e-commerce or other indirect transaction) via a network 116 (e.g., the Internet). In some embodiments, payment device 104 may interact with payment processing network 112 (or other entity in system 100) via network 116 to form a communications channel, such as through an Internet Protocol Gateway (IPG) 118. IPG 118 may be in operative communication with payment processing network 112. Although IPG 118 is shown as being a separate entity in FIG. 1, IPG 118 could be incorporated into payment processing network 112, issuer computer 114, or other entity in system 100, or could be omitted from system 100 in some embodiments. If IPG 118 is omitted, the communications channel could directly connect payment processing network 112 and payment device 104. In general, providing communication from user 102 to payment processing network 112 or other entity may enable a variety of increased functionalities to user 102, such as advanced authentication and verification methods (particularly in e-commerce and similar transactions), examples of which are described in U.S. Ser. No. 12/712,148 filed on Jul. 16, 2010 and U.S. Ser. No. 13/184,080 filed on Jul. 15, 2011, each of which is incorporated by reference herein in its entirety. However, embodiments are not so limited.

In some embodiments, an electronic or digital wallet (i.e. “e-Wallet”) may be utilized for conducting a financial transaction. As shown in FIG. 1, in such embodiments, system 100 may include an electronic wallet server 120, which may be accessible to user 102 via network 116 using, for instance, payment device 104 (either directly connected or through IPG 118). Electronic wallet server 120 may also be in operational communication with a merchant (e.g., via access device 106 or merchant computer 108), with payment processing network 112, and/or with issuer computer 114. In some embodiments, electronic wallet server 120 may comprise a part of payment processing network 112, issuer computer 114, or other entity in system 100. Electronic wallet server 120 may be programmed or configured to provide some or all of the functionality associated with conducting transactions using an electronic wallet, including maintaining an association between the user's e-wallet and one or more payment accounts such as a bank account, debit account, credit card account, prepaid account, and/or other suitable account, in an E-Wallet database 122. To provide electronic wallet services (i.e. the use of the electronic wallet associated with a payment account to conduct a financial transaction), electronic wallet server 120 may further provide a web interface (e.g. through one or more web pages) to receive and transmit requests for payments services and/or may provide an application program interface (API) (shown as electronic wallet client 104′) on payment device 104 to provide the web service. This process is described in more detail in U.S. Ser. No. 61/466,409 filed on Mar. 22, 2011, which is incorporated herein by reference in its entirety.

As noted above, the user's electronic wallet may be stored in E-Wallet database 122, which may include information associated with the user's payment accounts that can be used to conduct a financial transaction with a merchant. For instance, E-Wallet database 122 may include real account identifiers (e.g., PANs) for one or more payment accounts (e.g., payment accounts associated with a credit card, debit card, etc) of user 102. In some embodiments, E-wallet database 122 may additionally (or alternatively) include account tokens corresponding to such real account identifiers. The e-wallet may be populated with such information during an initial enrollment process in which user 102 enters information regarding one or more of the payment accounts that may be associated with various issuers. Once the payment account information is added to E-Wallet database 122, user 102 may perform transactions by utilizing only his e-wallet. When user 102 performs a transaction using his electronic wallet, user 102 need not provide the merchant with payment account information, but may instead provide the electronic wallet information. This information may then be included in an authorization request message, which in turn may be provided to payment processing network 112. Payment processing network 112 may then access the user's e-wallet via a request to electronic wallet server 120, or may have direct access to e-wallet database 122 so as to obtain the corresponding payment account information (e.g., account token, real account identifier, etc.) indicated by the information in the authorization request message.

Electronic wallet client 104′ may comprise any suitable software that provides front end functionality of the electronic wallet to user 102. For instance, electronic wallet client 104′ may be embodied as a software application downloadable by payment device 104 (e.g., a mobile phone). In some instances, electronic wallet client 104′ may provide a user interface (such as a series of menus or other elements) that allows user 102 to manage his electronic wallet(s) (i.e. electronic wallet client 104′ may enable interaction with electronic wallet server 120, and thereby e-wallet database 122). In some embodiments, electronic wallet client 104′ may store data in a computer readable memory for later use, such as user preferences, account tokens, token derivation keys, or other data elements associated with funding sources added to the electronic wallet.

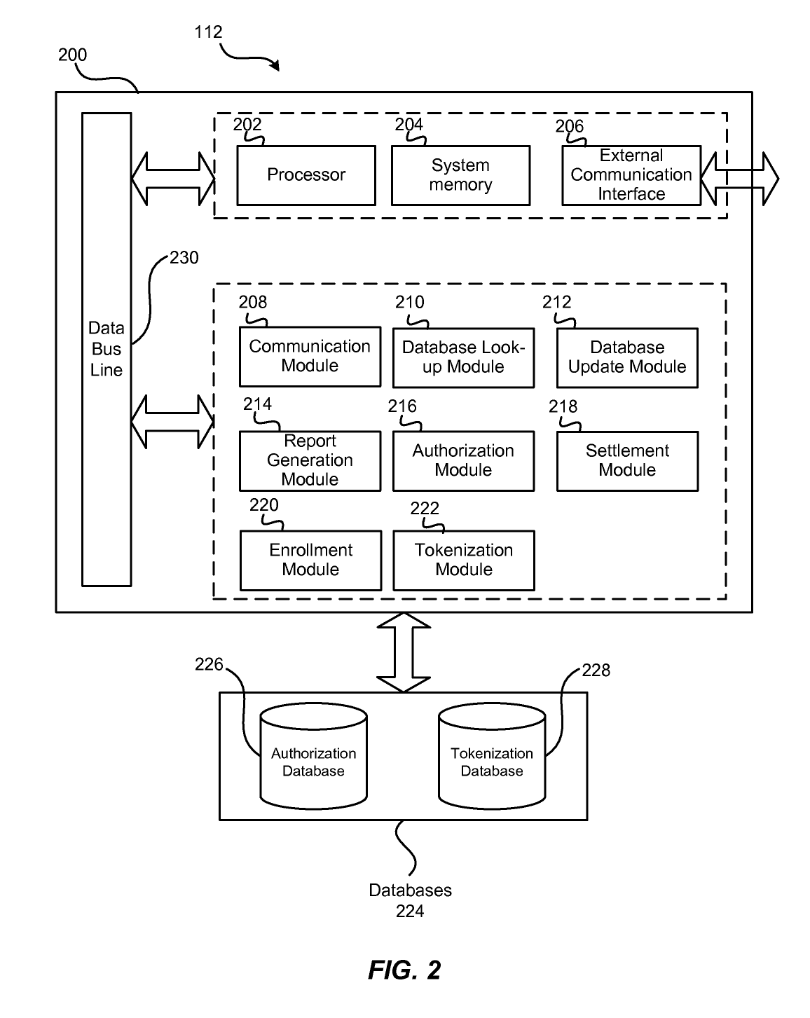

Payment processing network 112 may be disposed between acquirer computer 110 and issuer computer 114 in system 100. The components of payment processing network 112, according to embodiments of the invention, are described below with reference to FIG. 2. Furthermore, merchant computer 108, acquirer computer 110, payment processing network 112, and issuer computer 114 may all be in operative communication with each other (i.e. one or more communication channels may exist between each of the entities, whether or not these channels are used in conducting a financial transaction).

Payment processing network 112 may include data processing subsystems, networks, and operations used to support and deliver authorization services, exception file services, and clearing and settlement services. For instance, payment processing network 112 may comprise a server computer, coupled to a network interface (e.g. by an external communication interface), and a database(s) of information. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. Payment processing network 112 may use any suitable wired or wireless network, including the Internet.

Although many of the data processing functions and features of some embodiments may be present in payment processing network 112 (and a server computer therein), it should be understood that such functions and features could be present in other components such as issuer computer 114, and need not be present in payment processing network 112, or a server computer therein.

FIG. 2 illustrates a block diagram of an exemplary payment processing network 112 including a server computer 200 in accordance with some embodiments. The exemplary server computer 200 is illustrated as comprising a plurality of hardware and software modules (202-222). However, it should be appreciated that this is provided for illustration purposes only, and each of the modules and associated functionality may be provided and/or performed by the same or different components. That is, server computer 200 may, for instance, perform some of the relevant functions and steps described herein with reference to payment processing network 112 through the use of any suitable combination of software instructions and/or hardware configurations. It should be noted that although FIG. 2 illustrates all of the modules located on a single device, the disclosure is not meant to be so limited. Moreover, a system for implementing the functionality described herein may have additional components or less then all of these components. Additionally, some modules may be located on other devices such as a remote server or other local devices that are functionally connected to the server computer component(s).

Server computer 200 is shown as comprising a processor 202, system memory 204 (which may comprise any combination of volatile and/or non-volatile memory such as, for example, buffer memory, RAM, DRAM, ROM, flash, or any other suitable memory device), and an external communication interface 206. Moreover, one or more of the modules 208-222 may be disposed within one or more of the components of the system memory 204, or may be disposed externally. As was noted above, the software and hardware modules shown in FIG. 2 are provided for illustration purposes only, and the configurations are not intended to be limiting. Processor 202, system memory 204 and/or external communication interface 206 may be used in conjunction with any of the modules described below to provide a desired functionality. Some exemplary modules and related functionality may be as follows:

A communication module 208 may be configured or programmed to receive and generate electronic messages comprising information transmitted through system 100 to or from any of the entities shown in FIG. 1. When an electronic message is received by server computer 200 via external communication interface 206, it may be passed to communications module 208. Communications module 208 may identify and parse the relevant data based on a particular messaging protocol used in system 100. The received information may comprise, for instance, identification information, transaction information, and/or any other information that payment processing network 112 may utilize in processing or authorizing a financial transaction, or performing a settlement and clearing procedure. Communication module 208 may then transmit any received information to an appropriate module within server computer 200 (e.g., via a system bus line 230). Communication module 208 may also receive information from one or more of the modules in server computer 200 and generate an electronic message in an appropriate data format in conformance with a transmission protocol used in the system 100 so that the message may be sent to one or more components within system 100 (e.g., to issuer computer 114, acquirer computer 110, merchant computer 108, or other entity). The electronic message may then be passed to the external communication interface 206 for transmission. The electronic message may, for example, comprise an authorization response message (e.g. to be transmitted to a merchant conducting a transaction) or may be an authorization request message to be transmitted or forwarded to an issuer.

A database look-up module 210 may be programmed or configured to perform some or all of the functionality associated with retrieving information from one or more databases 224. In this regard, database look-up module 210 may receive requests from one or more of the modules of server computer 200 (such as communication module 208, authorization module 216, settlement module 218, enrollment module 220, tokenization module 222, or other module) for information that may be stored in one or more of databases 224. Database look-up module 210 may then determine and query an appropriate database. Database update module 212 may be programmed or configured to maintain and update databases 224, such as an authorization database 226 and a tokenization database 228. In this regard, database update module 210 may receive information about a user, financial institution, a payment device, and/or current or past transaction information from one of the modules discussed herein. This information may then be stored in the appropriate location in databases 224 using any suitable storage process.

Report generation module 214 may be programmed or configured to perform some or all of the functionality associated with generating a report regarding a user, an account, a transaction or transactions, or any other entity or category of information with regard to system 100. This may include, for instance, identifying patterns (such as patterns that indicate a fraudulent transaction or transactions) and generating one or more alerts that may be sent (e.g. via communication module 208 and external communication interface 206) to one or more entities in system 100, including user 102, payment device 104, access device 106, merchant computer 108, acquirer computer 110, issuer computer 114, or other entity. The report generation module may also, for instance, request information from one or more of databases 224 via database look-up module 210.

Authorization module 216 may be configured or programmed to perform some or all the functionality associated with authorizing a financial transaction associated with an authorization request message. The authorization request message may be generated by access device 106 or merchant computer 108, for instance, and may be associated with a transaction involving payment device 104. The authorization request message may include any suitable information that may be used to authorize or identify the transaction, and may be generated in response to an interaction between payment device 104 and access device 106. Authorization module 216 may, for instance, be programmed or configured to compare the information received by via the authorization request message with stored information (e.g., verification values) at server 200 or a database (e.g., authorization database 226). If the received and stored values match, in some embodiments, authorization module 216 may forward the authorization request message to issuer computer 114 using communication module 208 and external communication interface 206. If an authorization response message is received from issuer computer 114, authorization module 216 may be configured to transmit the authorization response message to acquirer computer 110 or merchant computer 108. In some embodiments, if the received and stored values match, authorization module 216 may authorize the transaction (or may be more likely to authorize the transaction) and may instruct communication module 208 to generate an authorization response message. Authorization module 216 may also be programmed or configured to execute any further operations associated with a typical authorization.

Enrollment module 220 may be configured or programmed to perform some or all the functionality associated with enrolling users (e.g., user 102) in a tokenization service provided by payment processing network 112 or other entity. In some embodiments, enrollment module 220 may receive an enrollment request from a user including an identifier of a payment device and a real account identifier. For instance, if payment device 104 is a mobile device, user 102 may access server computer 200 (e.g., via a web-based interface) to register a device ID of the mobile device in addition to a PAN corresponding to an account (e.g., a credit card account) of user 102. Enrollment module 220, in conjunction with tokenization module 222, may then generate and transmit an account token to payment device 104, the account token corresponding to the PAN. In some embodiments, enrollment module 220 may instead transmit one or more token derivation keys to payment device 104, that may be used to generate dynamic account tokens during future transactions.

Enrollment module 220 may be further configured to store a registration record for users in tokenization database 228 as part of the enrollment process. For instance, such a record may include a device ID associated with payment device 104, one or more reverse tokenization keys for converting the account token back into the real account identifier (e.g., the PAN), dynamic data elements usable for reverse-tokenization (e.g., a counter value, dCVV value, etc.), one or more token derivation keys, a look-up table that maps the account token to the real account identifier, and any other suitable information. In some embodiments, if payment device 104 is provisioned to store an account token or one or more token derivation keys at the time of issuance (e.g., by the issuer associated with issuer computer 114), the enrollment process may include an exchange of messages between server computer 200 and issuer computer 114, whereby a registration record for user 102 is stored by enrollment module 220 in tokenization database 228.

Tokenization module 222 may be configured or programmed to perform some or all the functionality associated with transforming account tokens into real account identifiers, and transforming real account identifiers into account tokens. For instance, upon receiving an enrollment request from user 102 or issuer computer 114, tokenization module 222 can generate an account token (e.g., using one or more token derivation keys stored in tokenization database 228), for transmission to payment device 104. In some embodiments, when an authorization request message is received including an account token, tokenization module 222 can transform the account token back into the real account identifier. For instance, tokenization module 222 can send a request to database look-up module 210 to retrieve the corresponding real account identifier from tokenization database 222. In another embodiment, tokenization module 222 may utilize one or more reverse tokenization keys (e.g., via a request to database look-up module 210 to retrieve such key(s) from tokenization database 228) to convert the account token into the real account identifier. Similarly, if an authorization response message is received including a real account identifier, and if the transaction has been declined by the issuer, tokenization module 222 may convert the real account identifier back into the account token using a look-up process or a tokenization process involving one or more token derivation keys.

Payment processing network 112 may include one or more databases 224, such as authorization database 215 and tokenization database 228. Each of the databases shown in this example may comprise more than one database, and may be located in the same location or at different locations. Authorization database 226 may contain information related to payment devices and payment accounts, as well as any other suitable information (such as transaction information) associated with the payment account. For instance, authorization database 226 may comprise a relational database having a plurality of associated fields, including a primary account identifier (e.g. a PAN), an issuer associated with the account, expiration date of a payment device, a verification value(s), an amount authorized for a transaction, a user name, user contact information, prior transaction data, etc. In some embodiments, authorization module 216 may utilize some or all of the information stored authorization database 226 when processing and/or authorizing a transaction.

Tokenization database 228 may contain information usable to transform account tokens into real account identifiers, and real account identifiers into account tokens. For instance, tokenization database 228 can include registration records for user enrolled in a tokenization service. Such records may include, for instance, device IDs associated with registered payment devices (e.g., payment device 104), reverse tokenization keys for converting account tokens back into the corresponding real account identifiers (e.g., PANs), dynamic data elements usable for reverse-tokenization (e.g., counter values, dCVV values, etc.), token derivation keys, look-up tables that map account token to real account identifiers, and any other suitable information.

In FIG. 2, server computer 200 is illustrated as comprising part of payment processing network 114. This, however, is not intended to be limiting. In embodiments of the invention, one or more of modules 208-222 and databases 224 may comprise part of any other suitable entity of system 100. For instance, in some embodiments, issuer computer 114 may convert account tokens into real account identifiers, and real account identifiers back into account tokens. In such embodiments, enrollment module 220, tokenization module 222, tokenization database 228, and/or any other module or database may be part of (or associated with) issuer computer 114.

II. Exemplary Methods

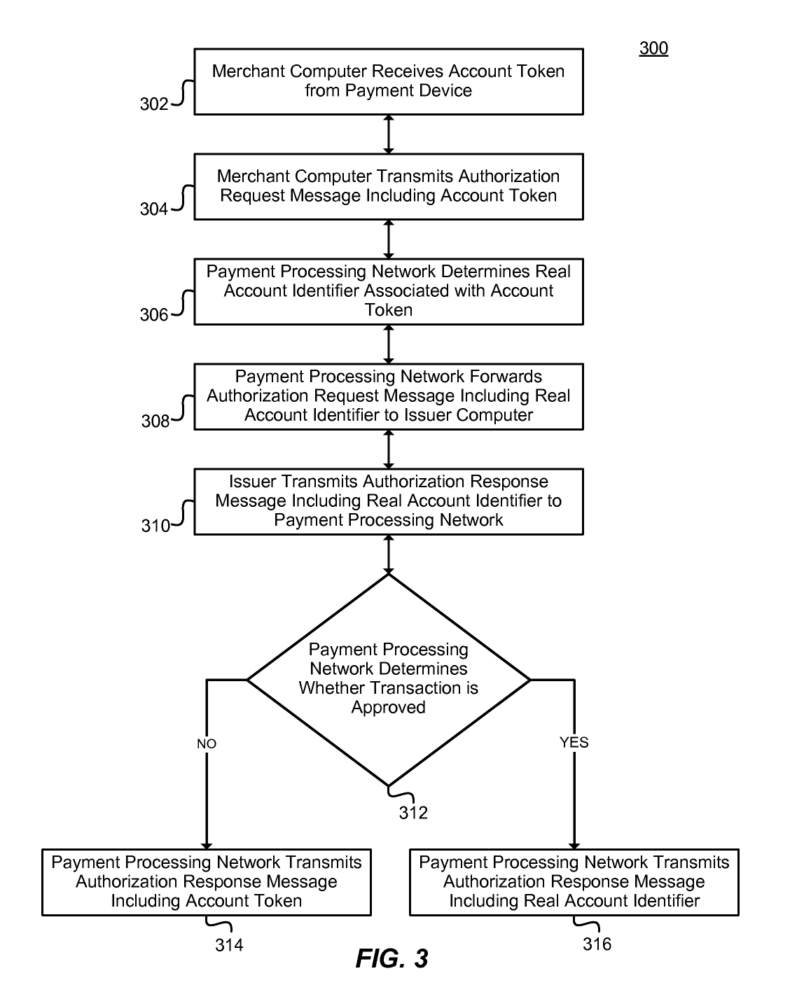

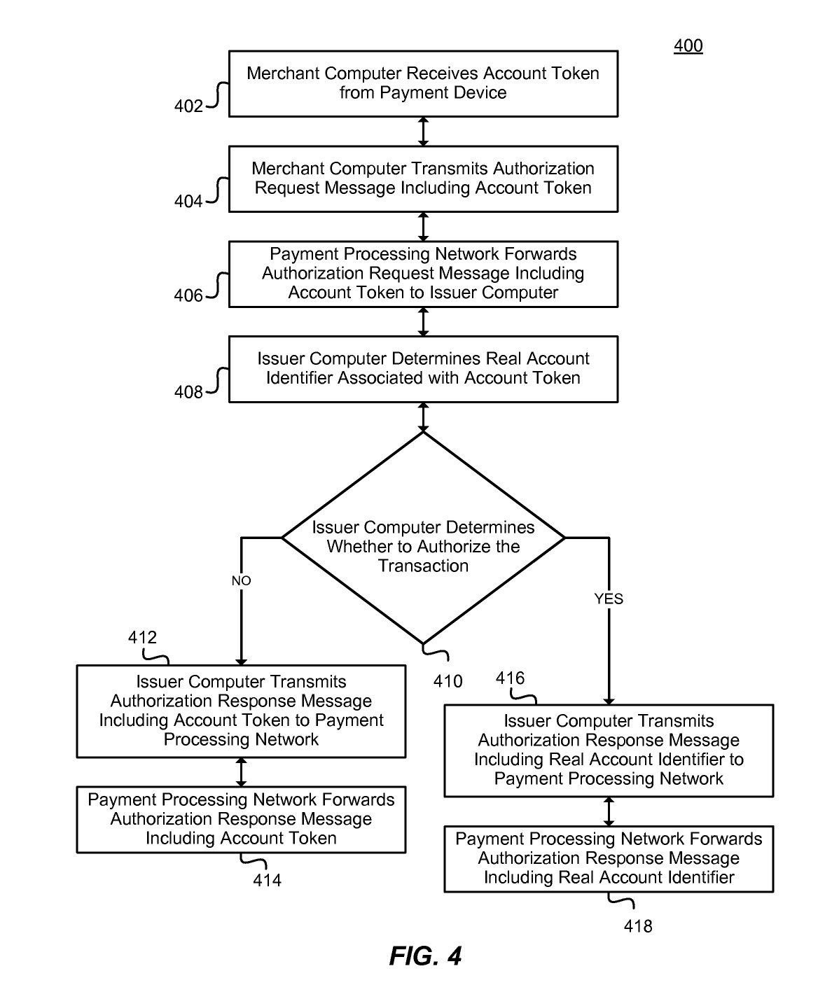

FIGS. 3-4 show flowcharts illustrating methods 300 and 400 in accordance with some embodiments. The steps of method 300 may be performed, for instance, by server computer 200, and the steps of method 400 may be performed, for instance, by issuer computer 114, as shown in FIG. 2. In other embodiments, one or more steps of methods 300 and 400 may be performed by any other suitable computer system shown in FIG. 1. In some embodiments, one or more steps of methods 300 and 400 may be performed by entities not shown in FIG. 1, such as merchant processors, issuer processors, acquirer processors, or any other suitable entity.

FIG. 3 shows a flowchart illustrating an exemplary method 300 of processing payment transactions by a payment processing network in accordance with some embodiments.

In FIG. 3, at step 302, method 300 may begin by a merchant computer receiving an account token from a payment device, the account token being associated with a real account identifier. For instance, as illustrated in FIG. 1, to initiate a transaction, user 102 can cause payment device 104 (e.g., a payment card, mobile phone, or the like) to interact with access device 106 (e.g., a POS terminal) which is communicatively coupled to merchant computer 108. As a result of this interaction, an account token can be transmitted (e.g., wirelessly) from payment device 104 to access device 106.

In some embodiments, the account token can be stored on payment device 104. For instance, payment device 104 may include a memory storing the account token when payment device 104 is issued to user 102, or the account token may be provided to payment device 104 by payment processing network 112 or the issuer during an enrollment process. Such an account token may be a “static” token usable for multiple transactions. In other embodiments, payment device 104 may be configured to generate a unique account token for each transaction. For instance, when issued to user 102 or as provided during an enrollment process, the memory of payment device 104 may store one or more token derivation keys. To generate the account token, payment device 104 can perform a tokenization algorithm whereby a real account identifier (e.g., a PAN) is transformed into the account token using one or more of the stored token derivation keys. In some embodiments, one or more token derivation keys can be derived at the time of transaction using a dynamic value associated with payment device 104, such as a counter value, dCVV value, or the like.

To illustrate, at step 302, a user may present a mobile phone to a contactless POS terminal at a merchant, during which the mobile phone may transform a PAN associated with a credit card account of the user into an account token. For instance, the mobile phone may select a token derivation key stored on the mobile phone, and may use the selected token derivation key to convert the PAN (e.g., “4128 0031 5728 0359”) into the account token (e.g., “412800777”). The mobile phone may transmit the generated account token to the POS terminal wirelessly using, for instance, a radio frequency (RF) communication protocol.

At step 304, the merchant computer may transmit an authorization request message for the transaction including the account token. For instance, after receiving the account token from payment device 104, access device 106 may generate an authorization request message including the account token in addition to other information received from payment device 104 and usable to perform an authorization process, identify the user's account, and to transform the account token into the real account identifier, such as the transaction amount, merchant identifier, merchant location, CVV, expiration date, cardholder name, a device ID that identifies payment device 104, etc. The generated authorization request message may also include dynamic values such as a counter value, a key index value, dCVV, etc. For instance, in some embodiments, the authorization request message may include a key index value generated by payment device 104 using the device ID and a transaction counter value.

In some embodiments, merchant computer 108 may transmit the authorization request message to a computer associated with the merchant's acquirer, i.e. acquirer computer 110. It should be noted that in some embodiments, a real account identifier may include a network identifier that indicates the appropriate payment processing network for routing an authorization messages. For instance, in the context of a 16-digit account number format, the first digit may act as a network identifier. In such embodiments, the generated account token may also include an identifier of the payment processing network that informs the acquirer of the appropriate payment processing network. Thus, at step 304, based on a network identifier in the account token, acquirer computer 110 can forward the authorization request message including the account token to the appropriate payment processing network (i.e. payment processing network 112).

Referring back to the above illustration, at step 304, the merchant's contactless POS terminal can generate an authorization request message including the account token (e.g., 412800777), a key index value (e.g., “ABCD10”) generated by the mobile phone using the device ID (e.g., “ABCD”) and a transaction counter value (e.g., “10”). The POS terminal and/or a merchant computer coupled to the terminal may transit the authorization request message to the merchant's acquirer. The acquirer may analyze the account token to determine the appropriate payment processing network (e.g., based on the first token value “4”), and may then forward the authorization request message to the determined network.

At step 306, upon receiving the authorization request message for the transaction including the account token, the payment processing network may determine the real account identifier associated with the account token. In some embodiments, a real account identifier can be represented as a sequence of characters or symbols such as a 16 digit PAN. Exemplary real account identifiers include, but are not limited to, credit card account numbers, debit card numbers, checking and savings account numbers, prepaid account numbers, and the like. At step 306, the real account identifier can be determined a number of different ways according to various embodiments. For instance, payment processing network 112 may utilize a look-up process whereby payment processing network 112 accesses a database (e.g., tokenization database 228 in FIG. 2) that maps the account token to the real account identifier. As another example, in some embodiments, payment processing network 112 may identify a reverse tokenization key corresponding to the account token, and may then use the reverse tokenization key to transform the account token back into the real account identifier. In some embodiments, the reverse tokenization key may be mapped to payment device 104, user 102, the user's account, and/or the account token in a database accessible to payment processing network 112 (e.g., tokenization database 228). In some embodiments, reverse tokenization keys may be further mapped to dynamic data values, such as counter values, dCVV values, key index values, and the like. For instance, in some embodiments, payment processing network 112 may identify the reverse tokenization key using a key index value included in the authorization request message.

Referring back to the above illustration, at step 306, the payment processing network can receive the authorization request message including the account token (e.g., “412800777”), device ID (“e.g., “ABCD”) and the key index value (e.g., “ABCD10”). The payment processing network may use the device ID to locate a stored registration record associated with the user, and that includes multiple reverse tokenization keys that are each assigned to a specific key index value. The payment processing network can select the token derivation key corresponding to the current key index value (e.g., “ABCD10”), and may then use the selected token derivation key to transform the account token (e.g., “412800777”) back into the PAN (e.g., “4128 0031 5728 0359”).

At step 308, the payment processing network can forward the authorization request message including the real account identifier to an issuer of the account. In some embodiments, one or more characters in a real account identifier (and/or account token) may identify the issuer of the account. Thus, upon determining the real account identifier, payment processing network 112 may analyze the real account identifier and determine that the issuer associated with issuer computer 114 is the issuer of the user's account. Payment processing network 112 can replace the account token in the authorization request message with the real account identifier, and may transmit the authorization request message including the real account identifier to issuer computer 114.

Referring back to the above illustration, at step 308, the payment processing network may transform the account token (e.g., “412800777”) in the authorization request message with the PAN (e.g., “4128 0031 5728 0359”). Based on one or more digits of the PAN and/or account token (e.g., “12800”), the payment processing network may identify the issuer of the user's credit card account. The payment processing network may then replace the account token in the authorization request message with the PAN, and may forward this authorization request message including the PAN to the issuer for authorization.

At step 310, the issuer may transmit an authorization response message including the real account identifier, the authorization response message indicating whether the transaction has been approved. In various embodiments, the issuer may determine whether to approve the transaction based on a number of factors such as the amount of the transaction, an amount of available credit associated with the account, an “open-to-buy” balance (i.e. the difference between the credit limit assigned to the account and the present account balance), a fraud risk determination, and other factors. Thus, at step 310, issuer computer 114 may transmit an authorization response message to payment processing network 112 that includes the real account identifier, and that indicates whether the transaction has been authorized (i.e. approved) by the issuer associated with issuer computer 114.

Referring back to the above illustration, at step 310, the identified issuer may generate and transmit an authorization response message to the payment processing network. The authorization response message can include an indication whether the transaction has been authorized (e.g., an approval code, a decline code, an error code, etc.) in addition to the PAN (e.g., “4128 0031 5728 0359”) associated with the user's credit card account.

At decision 312, the payment processing network determines whether the transaction has been approved. For instance, payment processing network 112 may analyze the authorization response message received from issuer computer 114 to determine whether it includes a data element indicating that the transaction has been approved by the issuer or a data element indicating that the transaction has been declined by the issuer. If the transaction has been approved, method 300 may proceed to step 316. In particular, upon determining that the transaction has been approved, at step 316, the payment processing network may transmit the authorization response message including the real account identifier back to the acquirer. For instance, in response to determining that the transaction has been approved, payment processing network 112 may forward the authorization response message including the real account identifier to acquirer computer 110. Upon receipt, acquirer computer 110 may transmit the authorization response message including the real account identifier to merchant computer 108, which may provide an indication to user 102 (e.g., via access device 106) that the transaction has been approved. The merchant and/or acquirer may then store a record of the transaction including the real account identifier.

Referring back to the above illustration, at step 316, since the transaction was approved, the payment processing network may then forward the authorization response message including the PAN (e.g., “4128 0031 5728 0359”) to the acquirer, which may in turn forward the message back to the merchant. The merchant may provide an indication to the user (e.g., via the POS terminal) that the transaction has been approved, and may store a record of the transaction including the PAN. The transaction including the PAN may be used for post-transaction activities such as clearing, settlement, a refund or return, etc.

If, however, the payment processing network determines at decision 312 that the transaction is not approved (e.g., due to a decline code, error code, or the like), method 300 may instead proceed to step 314. In particular, at step 314, the payment processing network may transmit an authorization response message including the account token to the acquirer. For instance, in response to determining that the transaction has been declined, at step 314, payment processing network 112 may replace the real account identifier included in the authorization response message with the originally received account token. Payment processing network 112 may then transmit the authorization response message including the account token to acquirer computer 110, which may then forward the message to merchant computer 108. An indication that the transaction has been declined can be provided to user 102 by merchant computer 108 (e.g., via access device 106).

Referring back to the above illustration, at step 314, since the transaction was not approved, the payment processing network may replace the PAN (e.g., “4128 0031 5728 0359”) included in the authorization response message received from the issuer with the account token (e.g., “412800777”). The payment processing network may then transmit the authorization request including the account token to the acquirer, which may in turn forward the message back to the merchant. Since the transaction is declined, the merchant and/or acquirer may not need the sensitive PAN as there may be no need for post-transaction activity such as clearing, settlement, returns, refunds, etc. Thus, the merchant receives the authorization response message but does not receive the PAN. Accordingly, the user's privacy is protected and their sensitive account information secured from malicious third parties or unscrupulous merchants.

In some embodiments, at step 310, the authorization response message received from the issuer may not include the real account identifier. In such embodiments, the payment processing network may insert the real account identifier (e.g., the PAN) into the authorization response message if the transaction has been approved, and may alternatively insert the account token into the authorization response message if the transaction has been declined by the issuer. Further, in some embodiments, for approved transactions, the acquirer may remove the real account identifier from the authorization response message prior to forwarding the message to the merchant. In such embodiments, the acquirer can perform clearing and settlement (and can facilitate chargebacks) without the merchant having to store the sensitive real account identifier.

Further, in some embodiments, if the transaction is approved, the payment processing network may transmit an authorization response message including both the real account identifier and the account token to the acquirer at step 316. In some embodiments, the acquirer can forward the authorization response message including both the real account identifier and the account token to merchant. Alternatively, in some embodiments, upon receipt of the authorization response message, the acquirer can remove the real account identifier and send the authorization response message including only the account token to the merchant. Thus, in such embodiments, the account token can be utilized by merchant and acquirer systems configured to process account tokens, the acquirer can receive the real account identifier for post-transaction activity (e.g., clearing, settlement, etc.), and the merchant can receive only the less sensitive account token for storage which may provide many of the advantages described herein such as added security, compliance with industry and government security/privacy standards, etc.

In some embodiments, if the merchant receives the real account identifier at step 316 from the acquirer for an approved transaction, all or a portion of the real account identifier can be provided to the user as part of a transaction record (e.g., a printed or digital receipt) for subsequent reconciliation by the user. For instance, if the real account identifier is a 16-digit PAN, the merchant can issue a receipt indicating the last four digits of the PAN. Alternatively, in some embodiments, for approved transactions, the acquirer can transmit only a portion of the real account identifier to the merchant. For instance, referring back to the 16-digit PAN example, upon receiving an authorization response message including the PAN, the acquirer can transmit only the last four digits of the PAN to the merchant. Thus, the merchant may be able to provide the user with information that may be used for subsequent reconciliation by the user, without the security risks associated with receiving and/or storing the complete real account identifier.

In some embodiments, an account token may be associated with multiple accounts. For instance, in the context of an electronic wallet transaction, the user's payment device may store a single account token that facilitates access to multiple accounts of the user for which real account identifiers (e.g., PANs) are stored in an electronic wallet database (e.g., E-wallet database 122 shown in FIG. 1). In such embodiments, when the user provides their account token to initiate a transaction, the payment processing network, issuer, or other entity that manages the electronic wallet service may attempt to use the accounts in the electronic wallet using an order of priority or other rules. For instance, if a transaction using a first account (e.g., a credit card account) is declined by the issuer of the first account, a second account (e.g., a debit card account) may be attempted. If the transaction using the second account is approved by the issuer of the second account, as described above, a real account identifier such as the PAN for the second account can be included in the authorization response message sent back to the acquirer and/or merchant. Thus, in such embodiments, the merchant may be informed of the particular account that was successfully used to make payment which would have otherwise been unascertainable to the merchant from just the account token.

As described above, in some embodiments, an issuer, instead of a payment processing network, may receive and reverse tokenize the account token, and may determine whether to include the real account identifier in generated authorization response messages. FIG. 4 shows a flowchart illustrating an exemplary method 400 of processing payment transactions by an issuer computer in accordance with some embodiments.

In FIG. 4, at step 402, method 400 may begin by a merchant computer receiving an account token from a payment device, the account token being associated with a real account identifier. At step 404, the merchant computer may transmit an authorization request message for the transaction including the account token. It should be noted that steps 402 and 404 of method 400 are at least somewhat similar as steps 302 and 304 of method 300. Accordingly, further details regarding steps 402 and 404 are described above with respect to steps 302 and 304.

At step 406, upon receipt of the authorization request message including the account token, the payment processing network may forward the message to the issuer of the account. For instance, payment processing network 112 may receive the authorization request message including the account token (e.g., “412800777”) from acquirer computer 110, and may forward the message to issuer computer 114. As described above, one or more characters in a real account identifier may identify the issuer of the account. Thus, in some embodiments, the account token may also include such characters such so that payment processing network 112 can identify the appropriate account issuer. As an example, digits 2 through 6 of the account token (e.g., “12800”) may identify the issuer associated with issuer computer 114.

At step 408, upon receiving the authorization request message including the account token, the issuer computer may determine the real account identifier associated with the account token. For instance, in some embodiments, issuer computer 114 may utilize a look-up process, one or more reverse tokenization keys, or any other suitable method to transform the account token (e.g., “412800777”) into the real account identifier (e.g., “4128 0031 5728 0359”). It should be noted that the real account identifier determination of step 408 performed by the issuer computer may involve at least somewhat similar processes as step 306 of method 300 performed by the payment processing network. Accordingly, further details regarding step 408 are described above with respect to step 306.

At decision 410, the issuer computer determines whether to approve the transaction. In various embodiments, as described above, the issuer may determine whether to approve the transaction based on a number of factors such as the amount of the transaction, an amount of available credit associated with the account, an “open-to-buy” balance (i.e. the difference between the credit limit assigned to the account and the present account balance), a fraud risk determination, and other factors. Thus, at decision 410, issuer computer 114 may analyze such factors and determine whether to authorize the transaction.

If the issuer decides to approve the transaction at decision 410, method 400 may proceed to step 416. In particular, upon deciding to approve the transaction, at step 416 the issuer may generate an authorization response message indicating the approval and including the real account identifier, and may transmit this message to the payment processing network. For instance, issuer computer 114 may generate and transmit an authorization response message to payment processing network 112 that includes the PAN (e.g., “4128 0031 5728 0359”) and an approval code. At step 414, the payment processing network may then forward this authorization response message to the acquirer which may transmit the message to the merchant. Thus, at step 414, payment processing network 112 can forward the authorization response message including the PAN to acquirer computer 110, which may forward the message to merchant computer 108. As described above in regards to method 300, the PAN or other real account identifier may be used by the merchant and/or acquirer for post-transaction activity such as clearing, settlement, refunds, returns, etc.

If, however, the issuer decides at decision 410 not to approve the transaction, method 400 may instead proceed to step 416. In particular, at step 416, the issuer may generate an authorization response message indicating that the transaction is not approved, and including the account token in lieu of the real account identifier. For instance, issuer computer 114 can generate and transmit an authorization response message to payment processing network 112, the authorization response message including the previously received account token (e.g., “412800777”) and a decline code, error code, or other code indicating that the transaction is not approved. At step 418, the payment processing network may then forward this authorization response message to the acquirer which may transmit the message to the merchant. Thus, at step 418, payment processing network 112 can forward the authorization response message including the account token to acquirer computer 110, which may then forward the message to merchant computer 108. As described above in regards to method 300, the PAN or other real account identifier may not be needed by the merchant and/or acquirer for transactions that are not approved by the issuer.

III. Exemplary Computer Apparatus

The various participants and elements described herein with reference to FIG. 1 may operate one or more computer apparatuses to facilitate the functions described herein. Any of the elements in FIGS. 1-2, including any servers or databases, may use any suitable number of subsystems to facilitate the functions described herein.

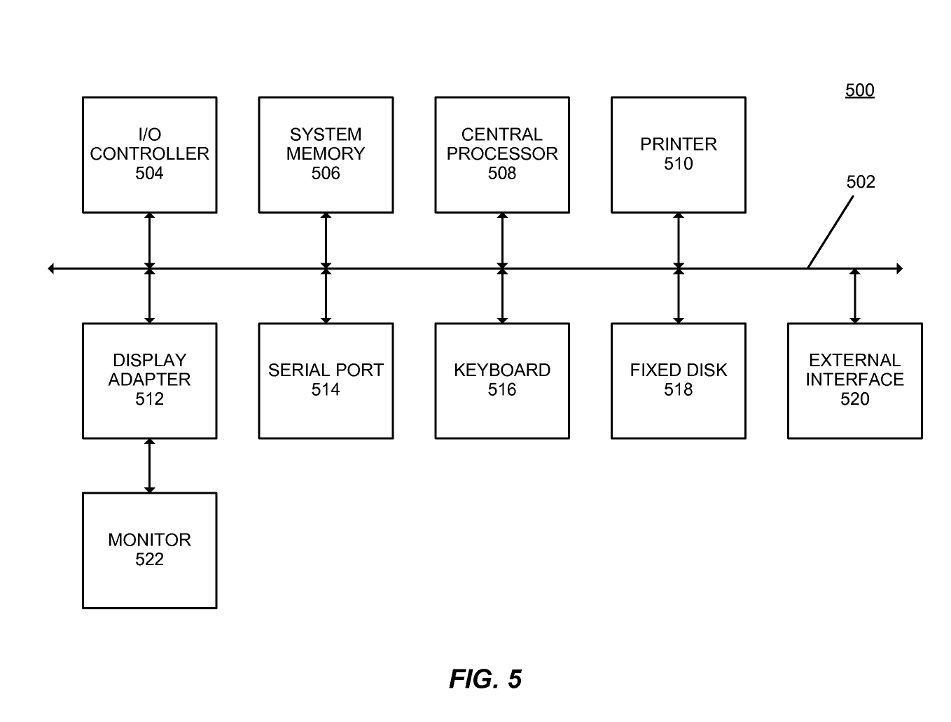

Examples of such subsystems or components are shown in FIG. 5 which illustrates exemplary computer apparatus 500. The subsystems shown in FIG. 5 are interconnected via a system bus 502. Additional subsystems such as a printer 510, keyboard 516, fixed disk 518 (or other memory comprising computer readable media), monitor 522, which is coupled to a display adapter 512, and others are shown. Peripherals and input/output (I/O) devices, which couple to I/O controller 504 (which can be a processor or other suitable controller), can be connected to the computer system by any number of means known in the art, such as a serial port 514. For instance, serial port 514 or an external interface 520 can be used to connect computer apparatus 500 to a wide area network such as the Internet, a mouse input device, or a scanner. The interconnection via system bus 502 allows a central processor 508 to communicate with each subsystem and to control the execution of instructions from a system memory 506 or fixed disk 518, as well as the exchange of information between subsystems. System memory 506 and/or fixed disk 518 may embody a computer readable medium.

Further, while the present invention has been described using a particular combination of hardware and software in the form of control logic and programming code and instructions, it should be recognized that other combinations of hardware and software are also within the scope of the present invention. The present invention may be implemented only in hardware, or only in software, or using combinations thereof.

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A computer-implemented method comprising:
receiving, by a server computer, an authorization request message for a transaction, wherein the authorization request message includes an account token associated with a real account identifier;
determining, by the server computer, the real account identifier associated with the account token; and
if the transaction is approved, transmitting an authorization response message including the real account identifier.

2. The method of claim 1, further comprising:
if the transaction is not approved, transmitting an authorization response message including the account token.

3. The method of claim 1, wherein determining the real account identifier associated with the account token comprises:
identifying a reverse tokenization key corresponding to the account token; and
using the reverse tokenization key to generate the real account identifier from the account token.

4. The method of claim 1, further comprising:
replacing the account token in the authorization request message with the real account identifier;
transmitting the authorization request message including the real account identifier to an issuer computer; and
receiving the authorization response message including the real account identifier from the issuer computer.

5. The method of claim 1, wherein the authorization response message is transmitted to a merchant computer or an acquirer computer.

6. The method of claim 1, further comprising:
receiving an enrollment request including an identifier of a payment device and the real account identifier;
using a token derivation key to generate the account token from the real account identifier; and
transmitting the account token to the payment device.

7. A server computer comprising:
a processor; and
a computer-readable medium coupled to the processor, the computer-readable medium including code executable by the processor for performing a method comprising:
receiving an authorization request message for a transaction, wherein the authorization request message includes an account token associated with a real account identifier;
determining the real account identifier associated with the account token; and
if the transaction is approved, transmitting an authorization response message including the real account identifier.

8. The server computer of claim 7, wherein the method further comprises:
if the transaction is not approved, transmitting an authorization response message including the account token.

9. The server computer of claim 7, wherein determining the real account identifier associated with the account token comprises:
identifying a reverse tokenization key corresponding to the account token; and
using the reverse tokenization key to generate the real account identifier from the account token.

10. The server computer of claim 7, wherein the method further comprises:
replacing the account token in the authorization request message with the real account identifier;
transmitting the authorization request message including the real account identifier to an issuer computer; and
receiving the authorization response message including the real account identifier from the issuer computer.

11. The server computer of claim 7, wherein the authorization response message is transmitted to a merchant computer or an acquirer computer.

12. The server computer of claim 7, wherein the method further comprises:
receiving an enrollment request including an identifier of a payment device and the real account identifier;
using a token derivation key to generate the account token from the real account identifier; and
transmitting the account token to the payment device.

13. A computer-implemented method comprising:
receiving, by a merchant computer, an account token from a payment device, wherein the account token is associated with a real account identifier; and
transmitting, by the merchant computer, an authorization request message for a transaction to a server computer, wherein the authorization request message includes the account token, and wherein the server computer:
determines the real account identifier associated with the account token; and
if the transaction is approved, transmits an authorization response message including the real account identifier.

14. The method of claim 13, wherein if the transaction is not approved, the server computer transmits an authorization response message including the account token.

15. The method of claim 13, wherein determining the real account identifier associated with the account token comprises:
identifying a reverse tokenization key corresponding to the account token; and
using the reverse tokenization key to generate the real account identifier from the account token.

16. The method of claim 13, wherein the server computer:
replaces the account token in the authorization request message with the real account identifier;
transmits the authorization request message including the real account identifier to an issuer computer; and
receives the authorization response message including the real account identifier from the issuer computer.

17. The method of claim 13, wherein the server computer transmits the authorization request message to the merchant computer or an acquirer computer.

18. The method of claim 13, wherein the server computer:
receives an enrollment request including an identifier of the payment device and the real account identifier;
uses a token derivation key to generate the account token from the real account identifier; and
transmits the account token to the payment device.

19. A system comprising:
a payment device configured to store an account token associated with a real account identifier;
a merchant computer configured to:
receive the account token from the payment device; and
transmit an authorization request message for a transaction including the account token; and
a server computer configured to:
receive the authorization request message including the account token from the merchant computer;
determine the real account identifier associated with the account token; and
if the transaction is approved, transmit an authorization response message including the real account identifier.

20. The system of claim 19, wherein the server computer is further configured to:
if the transaction is not approved, transmit an authorization response message including the account token.
